(19) United States
(12) Patent Application Publication
(10) Pub. No.: US 2017/0239788 A1
(43) Pub. Date: Aug. 24, 2017

(54) Pliers Comprising a Toggle Lever Drive

(71) Applicant: WEZAG GmbH Werkzeugfabrik, Stadtallendorf (DE)

(72) Inventor: Kurt Battenfeld, Ebsdorfergrund/Wittelsberg (DE)

(21) Appl. No.: 15/434,625

(22) Filed: Feb. 16, 2017

(30) Foreign Application Priority Data
Feb. 18, 2016 (EP) 16 156 231.9

(51) Int. Cl. B25B 7/12; B25B 7/22; B26B 17/02; B25B 7/02

(52) U.S. Cl. CPC B25B 7/123; B25B 7/02; B25B 7/22; B25B 7/126; B26B 17/02

(57) ABSTRACT

The invention relates to pliers (1). The pliers might be embodied as crimping pliers (2), cutting pliers or pipe crimping pliers. In the pliers (1) pliers jaws (3, 4) are driven by hand levers (8, 9) via a toggle lever drive (13). The toggle lever drive (13) is not formed by toggle lever rods or toggle lever bars. Instead, imaginary toggle levers are formed by a plurality of toggle lever components (35) which are movable along contact contours (30, 37; 33, 38) relative to each other.

### CROSS REFERENCE TO RELATED APPLICATIONS

This application claims priority to co-pending European Patent Application No. EP 16 156 231.9 filed Feb. 18, 2016.

### FIELD OF THE INVENTION

The present invention relates to pliers of any design wherein a toggle lever drive is used. In order to mention only some non-limiting examples, the pliers might be crimping pliers, pipe crimping pliers, crimping pliers for fittings or cutting pliers. It is possible that the pliers are manually actuated manual pliers comprising hand levers. However, it is also possible that the pliers are operated by a (in particular electric, hydraulic or pneumatic) drive, where in the case of using an electric drive the pliers might also be equipped with a rechargeable battery.

### BACKGROUND OF THE INVENTION

In known pliers, a toggle lever drive is used which is interposed between driving elements (in particular hand levers) and pliers jaws. By the toggle lever drive the driving movement of the driving elements is transformed into the movement of the pliers jaws. The transmission ration of the toggle lever drive might e.g. be dimensioned such that with common hand forces the operation of the hand levers over a larger pivoting angle leads to a smaller movement of the pliers jaws. Here, forces at the pliers jaws are increased due to the transmission and designated for processing a workpiece arranged between the pliers jaws. Dependent on a toggle lever angle which is formed between two toggle levers and changes over the working stroke, the transmission ratio of the toggle lever drive changes over the working stroke. The maximum of the force transmission ratio is given if the toggle lever approaches the extended position. This might e.g. be used such that when reaching the closed position of the pliers jaws the extended position is approached. Accordingly, in the beginning with the start of the closing movement caused by a movement of the driving elements, a comparatively large closing movement of the pliers jaws is produced so that comparatively small forces are generated at the pliers jaws. Towards the end of the closing movement where higher forces are required at the pliers jaws, the extended position is approached. Accordingly, at the end of the closing movement a corresponding movement of the driving elements leads to a smaller closing movement of the pliers jaws with larger forces generated at the pliers jaws. Examples for pliers of this type comprising a toggle lever drive are in particular known from the publications EP 2 905 848 A1 (corresponding to U.S. Pat. No. 9,242,349 B2), EP 2 672 581 A1, EP 2 305 428 A1 (corresponding to U.S. Pat. No. 8,516,872 B2), EP 1 724 101 A1, DE 10 2008 012 011 B3 (corresponding to U.S. Pat. No. 8,230,715 B2), DE 10 2008 005 472 B3 (corresponding to U.S. Pat. No. 8,245,560 B2), DE 10 2008 007 303 B4 (corresponding to U.S. Pat. No. 8,087,280 B2), DE 10 2007 001 235 B4 (corresponding to U.S. Pat. No. 8,127,589 B2), DE 103 46 241 B3 (corresponding to U.S. Pat. No. 7,155,954 B2), DE 101 40 270 B4, DE 101 32 413 C2 (corresponding to U.S. Pat. No. 6,877,228 B2), DE 100 56 900 C1 (corresponding to U.S. Pat. No. 6,612,147 B2), DE 199 63 097 C1 (corresponding to U.S. Pat. No. 6,474,130 B2), DE 199 24 087 C2 (corresponding to U.S. Pat. No. 6,289,712 B1), DE 199 24 086 C2 (corresponding to U.S. Pat. No. 6,286,358 B1), DE 197 09 639 A1, DE 197 13 580 C2 (corresponding to U.S. Pat. No. 5,913,933 A), DE 44 27 553 C2, DE 43 03 180 C1 (corresponding to U.S. Pat. No. 5,526,570 A, DE 37 08 727 C2 (corresponding to U.S. Pat. No. 4,794,780 A) and U.S. Pat. No. 6,161,416 A. The afore mentioned publications comprise examples for which different types of pliers a toggle lever drive might be used and for different ways of integrating a toggle lever drive into the drive mechanism of pliers. Furthermore, the mentioned prior art includes indications of embodiments wherein a movable pliers jaw is moved by a translational movement relative to a fixed pliers jaw.

WO 2008/128854 A1 (corresponding to U.S. Pat. No. 8,286,461 B2) discloses pliers comprising a fixed hand lever. The fixed hand lever is rigidly connected to a first pliers jaw. A supporting roller is supported for being rotated at the fixed hand lever. A second movable hand lever is connected for being rotated to a second pliers jaw. At a second joint the second pliers jaw is connected for being rotated to the first pliers jaw in a way such that the two pliers jaws are able to perform an opening or closing movement. During the closing stroke of the pliers a curvature part rolls with its outer contour along the supporting roller. The outer contour of the curvature part has a shape such that over the closing stroke the first joint and with the first joint the end of the movable pliers jaw connected to the movable hand lever are pushed away from the supporting roller. Accordingly, the movable pliers jaw is pivoted about the second joint so that the pliers jaws are pressed towards each other. Accordingly, in the pliers a toggle lever drive is used for generating the crimping force. A first toggle lever is here formed between the outer contour of the supporting roller and the first joint. At the supporting roller at a location between its rotational axis and its outer contour a second toggle lever is formed. Accordingly, the two toggle levers are each formed by a rigid component. The effective length of the first toggle lever changes over the closing stroke dependent on the outer contour of the curvature part.

### SUMMARY OF THE INVENTION

The present invention bases on the object to provide pliers wherein the two pliers jaws can be operated via a new type of toggle lever drive.

According to the prior art, a toggle lever drive is formed with two toggle levers. The toggle levers are each formed by toggle lever rods or toggle lever bars biased by tensile stresses or compression stresses (wherein these might also additionally be biased by a bending moment). Instead, the invention proposes that a first toggle lever of the toggle lever drive is formed with two toggle lever components formed as separate constructional elements. During the working stroke of the pliers, these two toggle lever components change their relative position. The toggle lever components move along contact contours relative to each other. This “multi-part” design of the first toggle lever opens new options on the one hand for the constructional design of the toggle lever drive and so for the pliers and on the other hand for the design of the drive mechanism and its constrains with respect to the constructional space. The first toggle lever and the second toggle lever do not form singular rod-like or bar-like components being physically present. Instead, the first toggle lever and the second toggle lever are toggle levers formed by one fictive component or a plurality of fictive components.

According to one embodiment, the pliers comprise a first pliers jaw and a second pliers jaw. The second pliers jaw comprises a first contact contour. The first pliers jaw and the second pliers jaw are supported for being pivoted relative to each other in a first swivel joint. Furthermore, the pliers comprise an actuation element. If the pliers are manual pliers, the actuation element is a movable hand lever. Instead, for non-manual pliers the actuation element might be actuated by the electric, hydraulic or pneumatic drive. The actuation element is supported for being pivoted relative to the first pliers jaw in a second swivel joint. The actuation element forms a second contact contour. The pliers also comprise a pressure body. The pressure body forms a third contact contour and a fourth contact contour. The third contact contour of the pressure body contacts the first contact contour of the second pliers jaw. Instead, the fourth contact contour of the pressure body contacts the second contact contour of the actuation element. The second pliers jaw, the pressure body and the actuation element are able to perform a relative movement when running through the working stroke of the pliers under a sliding movement along the contact contours. The toggle lever drive used for actuating the second pliers jaw is here formed by the second pliers jaw, the pressure body and the actuation element. The second pliers jaw, the pressure body and the actuation element each form a toggle lever component. A first toggle lever of the toggle lever drive is composed of these three toggle lever components. The length of the first toggle lever depends on the relative position of the second pliers jaw, the pressure body and the actuation element.

In the case that the pliers are manually actuated pliers, the pliers comprise a fixed hand lever which is fixedly connected to the fixed first pliers jaw or integrally formed with the first pliers jaw. In this case the actuation element comprises a movable hand lever. The actuation element further comprises a protrusion which forms the second contact contour.

For one embodiment of the pliers, a toggle lever component (in particular the actuation element) which is a part of the first toggle lever also integrally forms the second toggle lever. Accordingly, there is no physical toggle joint present. Instead, one toggle lever component of the first toggle lever and the second toggle lever are formed by an integral rigid constructional element and there is only an imaginary toggle joint. This imaginary toggle joint corresponds to the center of curvature of the second contact contour of the actuation element at the contact surface with the forth contact contour of the pressure body. So, a joint serving for the formation of a physical toggle joint is not required. Accordingly, a simplified construction of the toggle joint, improved design space requirement, an avoidance of a play in the region of a physical toggle joint and/or a reduction of the diversity of the constructional components might result.

The contact contours of the toggle lever components might be manufactured in any way. For a particular proposal, at least one contact contour of the toggle lever component is manufactured by punching. Here, it is possible to use a punching tool (in particular a bore punching tool) corresponding to the contact contour. It is generally possible that after the punching process there is an additional grinding post-processing. However, it is also possible that the contact contour is directly manufactured by punching (where in some cases after the punching there is still a slide grinding for removing any bur being present after the punching without any change of the contact contour). If it is required to manufacture two cooperating identical contact contours as a “positive contour and negative contour”, for a particular proposal the two contact contours are manufactured by one single punching tool. In this case, the punching of the two contact contours for the two cooperating toggle lever components is provided for one toggle lever component from its front side and for the other toggle lever component from its rear side. It is even possible that for the afore mentioned orientation of the two toggle lever components and sheet-swapped toggle lever components the contact contours are punched by one single punching process with one and the same punching tool. Here, for the punching the toggle lever component might have a plate-like design with a thickness in the region of 1 mm to 4 mm (preferably 1.5 mm to 3 mm or 1.8 mm to 2.5 mm).

Generally, any contact contours might be used. By the design of the contact contours the kinematic of the toggle lever drive might be affected. Accordingly, it is e.g. possible to change the effective length of the first toggle lever which is formed with the at least two toggle lever components when running through the working stroke. Here, the change of the effective length depends on the shape of the contact contour. For one embodiment of pliers, the contact contours have the shape of a circular arc. Contact contours having the shape of a circular arc lead to a good guidance of the toggle lever components contacting each other in the region of the contact contours during the working stroke. On the other hand, by use of contact contours having the shape of a circular arc it is possible to provide the transfer of the force between the contact contours (and so between the toggle lever components) via a large contact surface. Here, in a pair of contacting contact contours the contact contours might have a corresponding circular contour (leading to a pure relative rotational degree of freedom) or might have differing contours. The different pairs of contacting contours might have the same or differing radii.

As it can in particular be seen from the prior art cited above, it is possible to integrate the toggle lever drive in any way into the pliers resulting in different links of the pliers jaws with each other or with components of the pliers. Accordingly, it is e.g. possible that the two pliers jaws are linked to each other in the region of a pliers head. For a particular embodiment of the pliers, one pliers body integrally or rigidly forms the fixed first pliers jaw and the fixed hand lever. In this case, the movable second pliers jaw can be linked to the pliers body in the region of the fixed hand lever. Preferably, the movable pliers jaw is linked to the end region of the fixed hand lever facing away from the pliers head. This embodiment bases upon the finding that during a pivoting movement of the two pliers jaws relative to each other a die, a cutting edge or any tool is not moved by a purely translational closing movement. Instead, the closing movement also leads to a superimposed pivoting of the dies, cutting edges or tools. This pivoting movement might be disadvantageous for the workpiece that is to be processed. A pivoting movement of this type e.g. leads to a declined curling of crimping claws of a plug which is to be crimped or leads to a torque applied upon the plug. A reduction of this undesired pivoting movement can be achieved by a dislocation of the linking point of the two pliers jaws with each other away from the dies, cutting edges or working tools into the (end-)region of the hand lever.

According to another proposal, the first toggle lever comprises three toggle lever components. Here, one toggle lever component forms a pressure body. The pressure body comprises two contact contours. By the two contact contours the pressure body cooperates with a respective contact contour of the two other toggle lever components. Here, the pressure body allows a relative movement between the two other toggle lever components. Despite of this relative movement, the pressure body serves for transferring a pressing force between the other toggle lever components. Here it is possible that a toggle lever component actuated by the pressure body is rotatably mounted or also fixedly mounted to a movable pliers jaw or formed by the movable pliers jaw itself.

The pliers might comprise at least one opening spring of any type which automatically returns the pliers back into an open position after the generation of the closing movement. Here, at least one opening spring might be effective over the whole working stroke. In some cases the arrival at the closed position with the arrival at the extended position of the toggle lever drive might cause problems. In some cases it might be advantageous if the opening spring only comes into effect at the end of the closing stroke. In this case the opening spring is only responsible to again open the toggle lever drive a certain path away from the extended position after the termination of the closing stroke in order to avoid a clamping or blockage of the toggle lever drive. The at least one opening spring might be integrated in any way into the drive mechanism of the pliers. If in the pliers the first toggle lever is formed by the pressure body, it is possible that the pressure body is biased by an opening spring. This embodiment uses the advantage that the pressure body changes its angular position relative to the fixed pliers jaw, relative to the fixed hand lever or relative to the pliers body forming the fixed pliers jaw and the fixed hand lever during the working stroke. Accordingly, a spring base of the opening spring can be linked to the fixed pliers jaw, the fixed hand lever or the pliers body, whereas the other spring base of the opening spring is linked to the pressure body.

For the constructive design of the opening spring there are a lot of different options. It is e.g. possible that a torsional spring, a compression spring or a pulling spring, a torsional leg spring and the like is used. For a particular proposal, the opening spring is formed by a leaf spring or bending spring which is biased by a bending moment. It is possible that the leaf spring or bending spring extends approximately parallel to of the hand levers. In this context, “approximately parallel” means any orientation and arrangement of the leaf spring or bending spring for which the leaf spring or bending spring is (independent on the position in the working stroke) still integrated into the hand lever or for which the leaf spring or bending spring does not significantly protrude from the hand lever. Here, it is possible that the leaf spring or bending spring is fixed to the end region of the hand lever facing away from the pliers head so that in some cases the leaf spring or bending spring might have a considerable length which is e.g. larger than the half of the longitudinal extension of the pliers.

For another embodiment of the pliers, a toggle lever component is (directly or indirectly) rigidly connected to the movable hand lever. It is alternatively or cumulatively possible that a toggle lever component is (directly or indirectly) rigidly or pivotably connected to the fixed hand lever.

The invention also proposes that the movable hand lever is formed by a pliers body. This pliers body can be used in a multifunctional way wherein the pliers body also (integrally or rigidly) forms the second toggle lever, a toothing of a forces locking unit, a stop for defining a closed position and/or a contact contour.

Generally, the toggle lever drive might be arranged at any location of the pliers. For one embodiment of the pliers, the toggle lever drive is arranged between the hand levers and dies. It is possible that the dies are fixedly or exchangeably supported by the pliers jaw or that the dies form an integral part of the pliers jaw. The dies, the toggle lever drive and the hand levers in this sequence follow to each other along the longitudinal axis or even directly follow to each other. Here, the toggle lever drive preferably does not extend in a region lateral from the dies as being the case in particular for the publication U.S. Pat. No. 6,161,416 A. So, it is possible to reduce the lateral dimension of the pliers head so that it is also possible to use the pliers in constricted spaces.

There are a plurality of options for the geometric design of the outer dimensions of the pliers and the kinematic conditions for the use of the same. For one embodiment, the angle of the pliers jaws changes during the working stroke by less than 5° (preferably less than 4° or even less than 3.5°). In this way the application of an undesired torsional moment upon the workpiece is at least reduced. The length of the pliers might be less than 250 mm. The height of the pliers can be less than 60 mm despite of the integration of the forced locking unit and/or the thickness of the pliers can be less than 15 mm. Preferably, all of the afore mentioned geometric conditions are fulfilled by one embodiment of the pliers, wherein also deviations of plus/minus 20% or plus/minus 10% of the geometric conditions are possible.

For another proposal, at least one opening spring is integrally formed by a toggle lever component. Here, the opening spring is preferably formed by an elastic spring arm, protrusion or an elastic web of the toggle lever component. In this way it is possible to use the toggle lever component in a multifunctional way and to further reduce the number of components. Here, the opening spring formed integrally by the toggle lever component might be effective over the whole working stroke or only close to the closing position.

Preferably, the pliers are pipe crimping pliers, crimping pliers or cutting pliers.

The afore mentioned feature might be used alternatively or cumulatively in inventive pliers.

Advantageous developments of the invention result from the claims, the description and the drawings. The advantages of features and of combinations of a plurality of features mentioned at the beginning of the description only serve as examples and may be used alternatively or cumulatively without the necessity of embodiments according to the invention having to obtain these advantages. Without changing the scope of protection as defined by the enclosed claims, the following applies with respect to the disclosure of the original application and the patent: further features may be taken from the drawings, in particular from the illustrated designs and the dimensions of a plurality of components with respect to one another as well as from their relative arrangement and their operative connection. The combination of features of different embodiments of the invention or of features of different claims independent of the chosen references of the claims is also possible, and it is motivated herewith. This also relates to features which are illustrated in separate drawings, or which are mentioned when describing them. These features may also be combined with features of different claims. Furthermore, it is possible that further embodiments of the invention do not have the features mentioned in the claims.

The number of the features mentioned in the claims and in the description is to be understood to cover this exact number and a greater number than the mentioned number without having to explicitly use the adverb “at least”. For example, if an opening spring is mentioned, this is to be understood such that there is exactly one opening spring or there are two opening springs or more opening springs. Additional features may be added to these features, or these features may be the only features of the respective product.

The reference signs contained in the claims are not limiting the extent of the matter protected by the claims. Their sole function is to make the claims easier to understand.

### BRIEF DESCRIPTION OF THE DRAWINGS

In the following, the invention is further explained and described with respect to preferred exemplary embodiments illustrated in the drawings.

FIGS. 1 and 2 show three-dimensional representations of pliers in a closed position (FIG. 1) and in an open position (FIG. 2.)

FIGS. 3 and 4 show a plan view of the pliers of FIGS. 1 and 2 with a disassembled cover plate and a disassembled pliers jaw in the closed position (FIG. 3) and in the open position (FIG. 4).

FIGS. 5 and 6 show a detail of the toggle lever drive of the pliers of FIGS. 1 to 4 in the open position (FIG. 5) and in the closed position (FIG. 6).

FIGS. 7 to 13 show plate-shaped components of the pliers of FIGS. 1 to 6 in a plan view.

FIGS. 14 to 18 show further embodiments of crimping pliers with a disassembled cover plate and one disassembled pliers jaw.

FIGS. 19 and 20 in a plan view show pliers embodied as pipe crimping pliers with a disassembled cover plate in a closed position (FIG. 19) and in an open position (FIG. 20).

FIGS. 21 and 22 in a detail show the toggle lever drive of the pliers of FIGS. 19 and 20 in the closed position (FIG. 21) and in the open position (FIG. 22).

FIG. 23 shows in a three-dimensional view the pliers of FIGS. 19 to 22 in the closed position.

### DETAILED DESCRIPTION

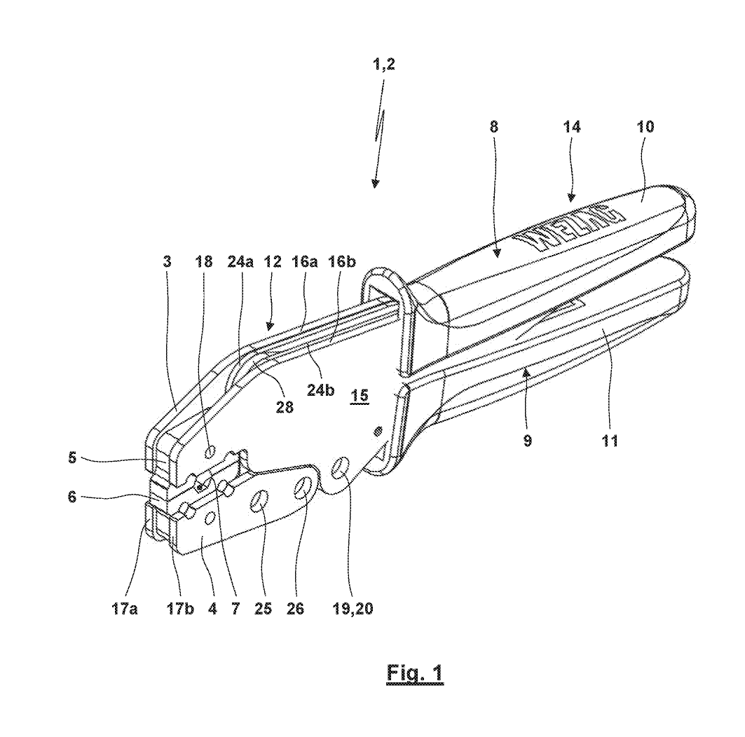

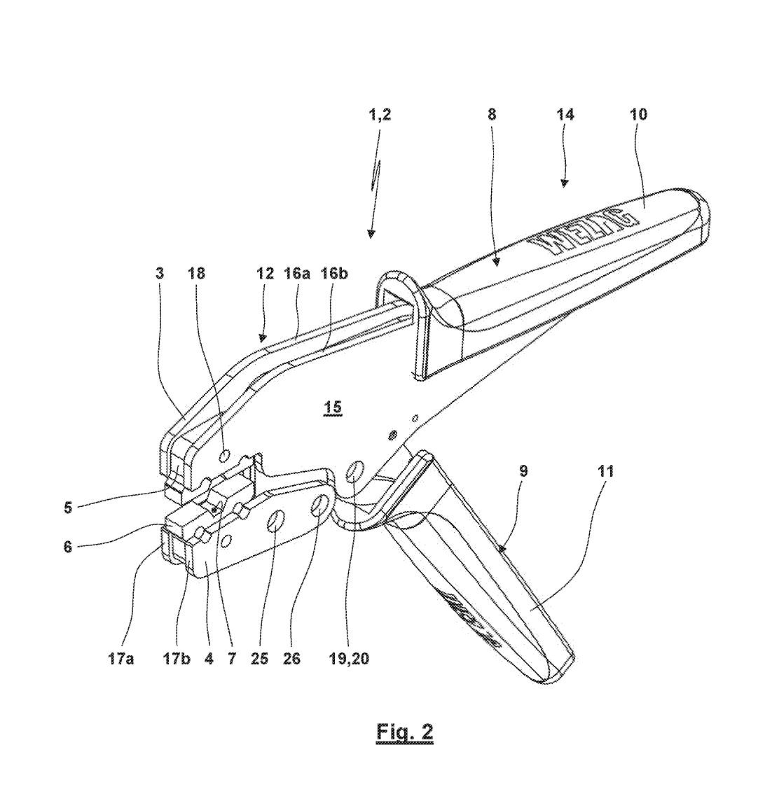

FIGS. 1 and 2 show pliers 1 embodied as crimping pliers 2 wherein a first die 5 and a second die 6 for crimping a workpiece as a plug are held by pliers jaws 3, 4. The workpiece is crimped in an accommodation 7 formed by the dies 5, 6. The pliers 1 have a plate design wherein plates are assembled with each other by fixation bolts or swivel bolts.

The pliers 1 comprise a fixed hand lever 8 fixedly connected to a fixed pliers jaw 3 as well as a movable hand lever 9 connected by a driving connection to a movable pliers jaw 4. The hand lever 9 forms an actuation element 70. If the pliers 1 are (differing from the shown embodiment) not manually actuated, a corresponding actuation element is actuated by the pneumatic, hydraulic or electric drive. In this case, instead of the fixed hand lever 8 a supporting element mounted to the housing of the drive might be used.

The hand levers 8, 9 comprise handles 10, 11 made of plastic. The pliers 1 comprise a pliers head 12. The dies 5, 6 and a driving mechanism including a toggle lever drive 13 are arranged in the region of the pliers head 12. The pliers 1 also comprise an actuation part 14. The hand levers 8, 9 are arranged in the region of the actuation part 14. The pliers head 12 and the actuation part 14 follow up to each other when seen along a longitudinal axis of the pliers 1.

The fixed pliers jaw 3 and the fixed hand lever 8 are formed by a pliers body 15. The pliers body 15 comprises two cover plates 16a, 16b extending parallel to each other under the build-up of an intermediate space. The driving mechanism and the toggle lever drive 13 are arranged in the intermediate space. In a corresponding way the pliers jaw 4 is formed with two pliers jaw plates 17a, 17b. The die 6 extends in an intermediate space between the pliers jaw plates 17a, 17b.

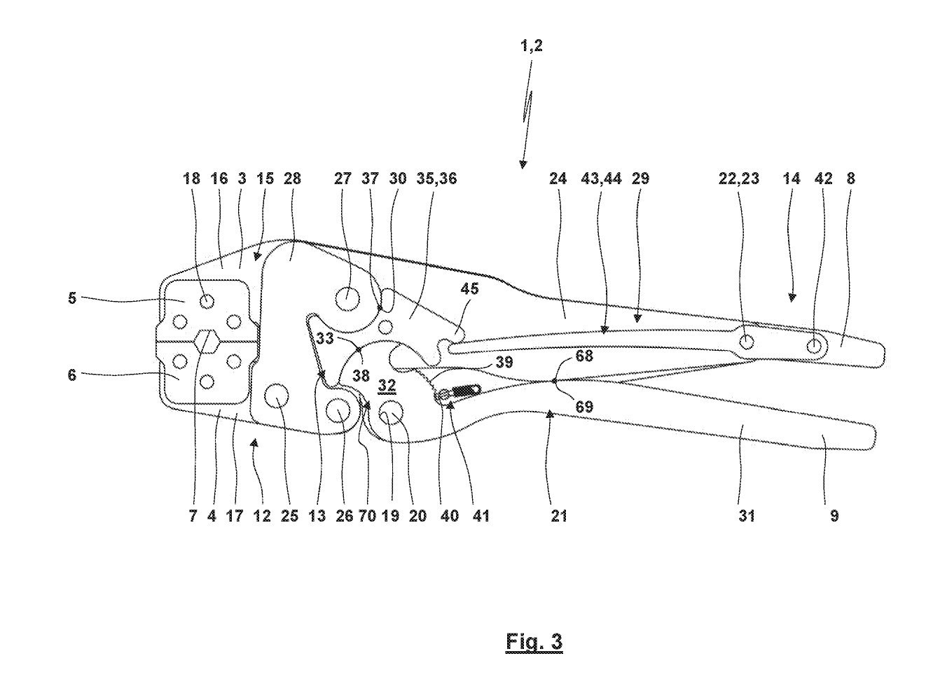

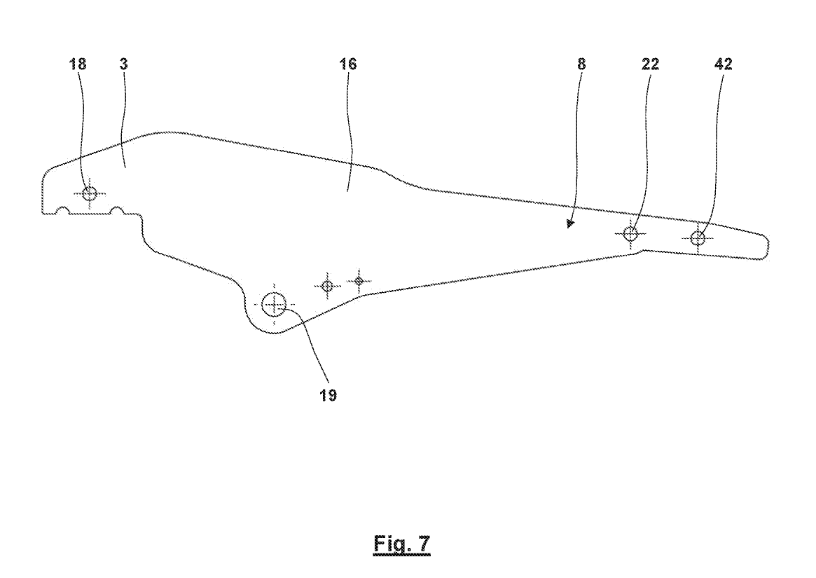

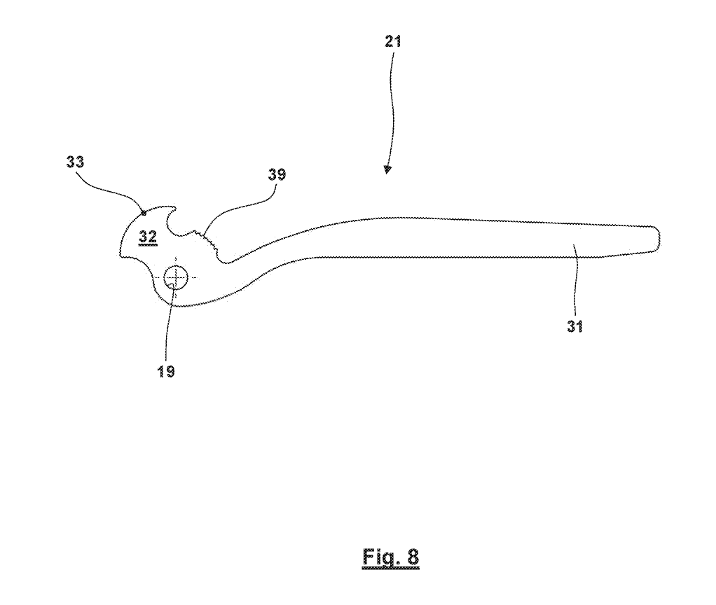

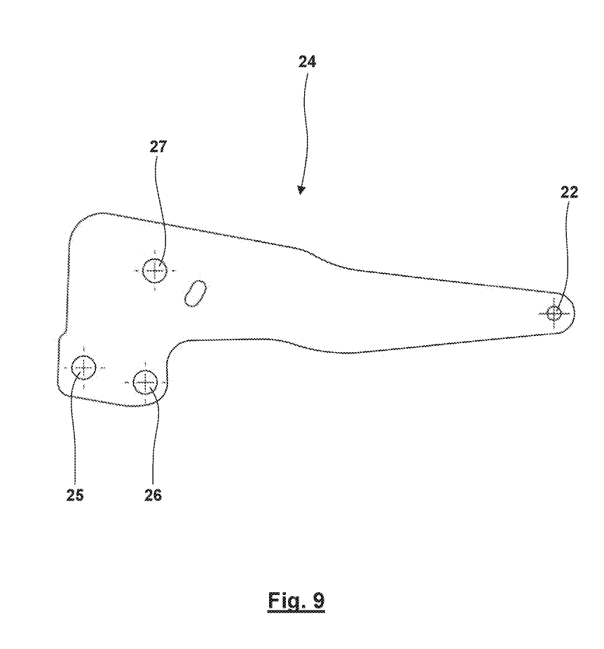

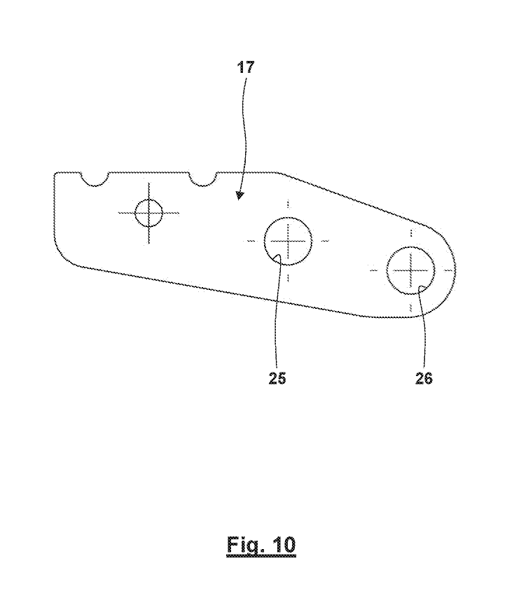

FIG. 3 shows the pliers of FIG. 1 in a closed position in a plan view. In the plan view the cover plate 16b and the pliers jaw plate 17b as well as the handles 10, 11 have been disassembled. The die 5 is mounted to the cover plates 16 shown in FIG. 7 by a bolt extending through mounting bores 18. A swivel bolt extending through the bearing bores 19 forms a (first) swivel joint 20 wherein a pliers body 21 (cp. FIG. 8) is held for being pivoted by the pliers body 15. Another swivel bolt extending through a bearing bore 22 forms a (second) swivel joint 23 wherein a pliers jaw supporting plate 24 shown in FIG. 9 is supported for being pivoted at the pliers body 15. The swivel joint 23 is arranged in the end region of the hand lever 8 facing away from the pliers head 12 (preferably at a distance in the region of 2 cm to 7 cm from the end region of this hand lever 8). By mounting bores 25, 26, 27 and mounting bolts extending there through the pliers jaw plates 17a, 17b shown in FIG. 10 and a toggle lever component 28 shown in FIG. 11 are mounted to the pliers jaw supporting plate 24. Accordingly, the pliers jaw supporting plate 24, the pliers jaw plates 17 and the toggle lever component 28 together form a pliers body 29. For the user of the pliers 1 it is primarily possible to see the relative movement of the pliers bodies 15, 21, 29, whereas other moved components of the pliers 1 are arranged in the intermediate space of the pliers 1, namely in the intermediate space between the cover plates 16a, 16b.

The toggle lever component 28 on the one hand serves for stiffening the pliers body 29 against the large forces being present. Furthermore, the toggle lever component 28 forms a (first) contact contour 30. Here, the contact contour 30 has the shape of a circular arc and the contact contour 30 is arranged concentrically to the mounting bore 27.

The pliers body 21 pivoted about the swivel joint 20 on the one hand forms a hand lever plate 31. The pliers body 29 is cranked comprising a protrusion 32 which is cranked relative to the hand lever plate 31. The longitudinal axis of the protrusion 32 forms a reflex angle or an angle of more than 90° relative to the longitudinal axis of the hand lever plate 31. The swivel joint 20 is located in the region of the cranking of the pliers body 29. The end region of the protrusion 32 facing away from the swivel joint 20 forms a (second) contact contour 33. Here, also the contact contour 33 is formed with the shape of a circular arc. The radius of this contact contour 33 is preferably larger than the radius of the contact contour 30. However, the center of curvature 34 of the contact contour 33 is not arranged in the region of the pivot axis of the swivel joint 20 but arranged between the pivot axis of the swivel joint 20 and the contact contour 33.

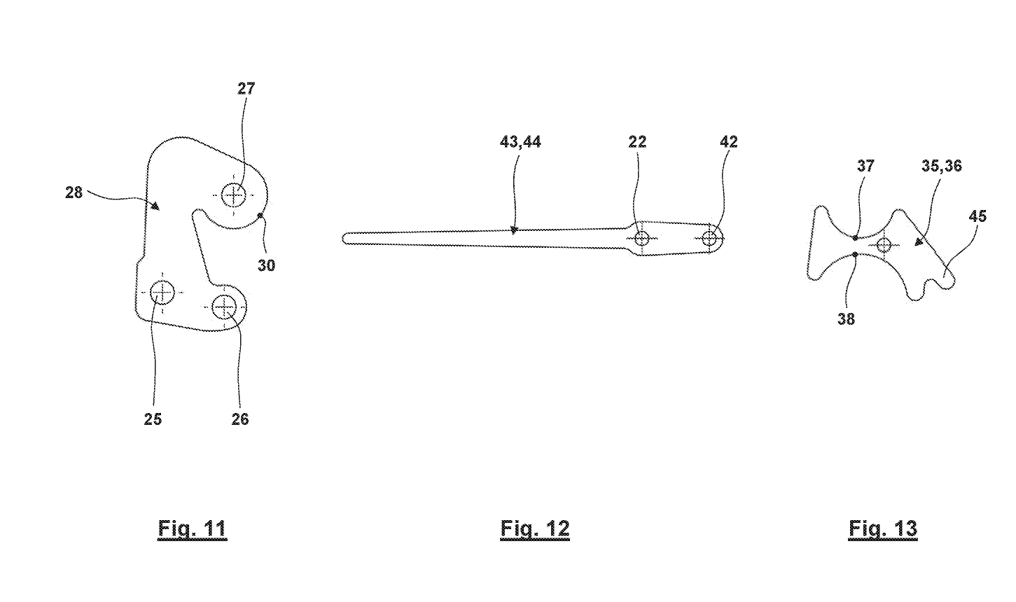

A toggle lever component 35 is effective between the protrusion 32 of the pliers body 21 and the toggle lever component 28. The toggle lever component 35 forms a pressure body 36 (cp. also FIG. 13). This toggle lever component 35 forms a (third) contact contours 37 and a (forth) contact contour 38 on its opposing sides. Here, the contact contour 37 of the toggle lever component 35 corresponds to the contact contour 30 of the toggle lever component 28. The contact contour 38 of the toggle lever component 35 corresponds to the contour 33 of the protrusion 32 of the pliers body 21. The respective associated contact contours 37, 30 and 38, 33 are inverted to each other so that one of the afore mentioned contact contours 30, 33 is convex and the other associated contact contour 37, 38 is concave.

In a circumferential region around the swivel joint 20 the pliers body 21 forms a toothing 39. A spring-biased latching element 40 of a forced locking unit 41 engages with the toothing 39. By means of the forced locking unit 41, in a generally known fashion it is provided that an intermediate position once reached during the working stroke is secured and a reopening of the pliers is only possible if the whole working stroke has been passed.

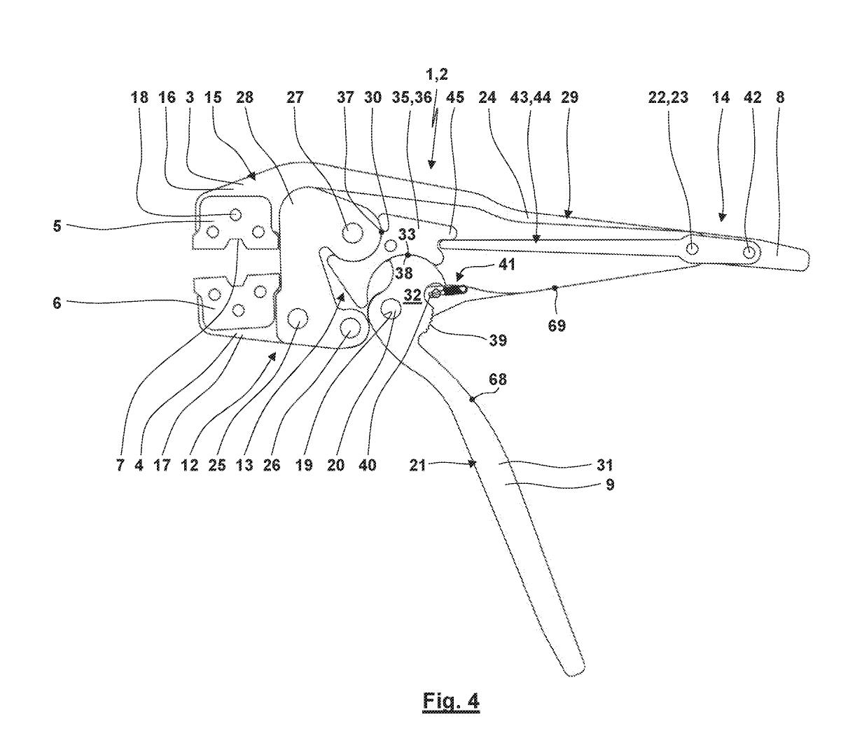

Adjacent to the bearing bore 22 the cover plates 16 comprise a mounting bore 42. An opening spring 43 (here a leaf spring of bending spring 44 (cp. FIG. 12)) is fixed to the cover plates 16 by a fixation bolt extending through the mounting bore 42 and by the bolt extending through the bearing bore 22. From this fixation in the end region of the hand lever 8 the leaf spring or bending spring 44 extends parallel to the hand lever 8 up to the region of the pliers head 12. The end region of the leaf spring or bending spring 44 opposite to the fixation to the cover plates 16 cooperates with a protrusion 45 of the toggle lever component 35 such that when running through the working stroke from the open position according to FIG. 4 in closing direction a pivoting movement of the toggle lever component 35 (which will be further described in the following) leads to a biasing of the leaf spring or bending spring 44 in counter-clockwise direction. With the release of the hand levers 8, 9 after the termination of the working stroke the leaf spring or bending spring 44 causes an opposite opening movement of the toggle lever component 35 for a re-establishment of the open position.

The cover plates 16 and the pliers jaw plates 17 have a thickness of e.g. 3 mm. The distance of the cover plates 16 and the pliers jaw plates 17 is 6 mm. In the intermediate space defined in this way the dies 5, 6 (having a thickness of 6 mm) extend. The toggle lever component 28, the toggle lever component 35, the leaf spring or bending spring 44 and the pliers body 21 are arranged in the same pliers plane and comprise the same thicknesses, namely a thickness of 2 mm. On both sides from these planes the pliers jaw supporting plates 24 extend. The pliers jaw supporting plates 24 each have a thickness of 2 mm.

The mode of operation of the pliers 1 of FIGS. 1 to 6 is as follows:

If the pliers 1 are in the open position of FIGS. 2 and 4, the hand levers 8, 9 have a maximum opening angle and the pliers jaws 3, 4 with the dies 5, 6 have a maximum distance. Preferably, the pliers jaws 3, 4 with the dies 5, 6 form an angle <4° due to the fact that their link for being pivoted is located in the region of the swivel joint 23. When starting from this open position the working stroke is passed in closing direction. The pivoting of the movable hand lever 9 towards the fixed hand lever 8 leads to a pivoting of the protrusion 32 with the contact contour 33. This pivoting movement leads to the result that the contact contour 33 performs a relative movement relative to the contact contour 38 of the toggle lever component 35. Due to the fact that the center of curvature of the contact contour 33 differs from the pivot axis 36 of the swivel joint 20, the toggle lever component 35 moves in FIG. 4 in clockwise direction relative to the contact contour 30 of the toggle lever component 28. Due to the increase of the distance of the pivot axis 36 of the swivel joint 20 from the contact contour 30 of the toggle lever component 28 (and so from the center of curvature 67 of the contact contour 30), a pivoting movement of the pliers body 29 in closing direction takes place. The pivoting movement of the toggle lever component 35 has the consequence that (starting from the open position in FIG. 4) with the run through the working stroke the leaf spring or bending spring 44 is increasingly biased. The operating position of the pliers 1 at the end of this closing movement is shown in FIGS. 1 and 3.

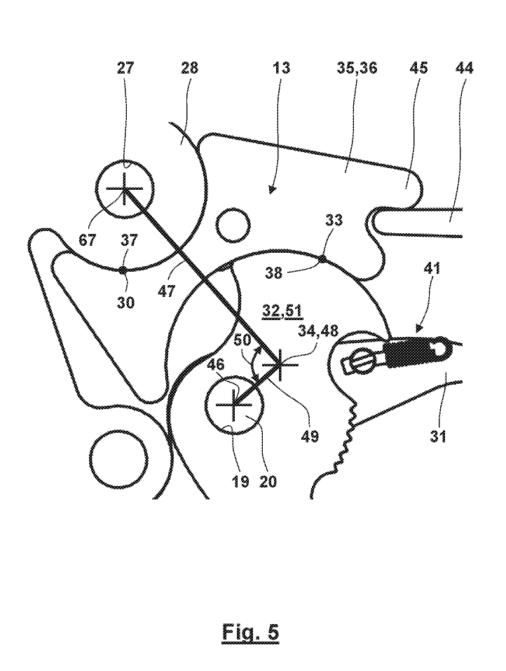

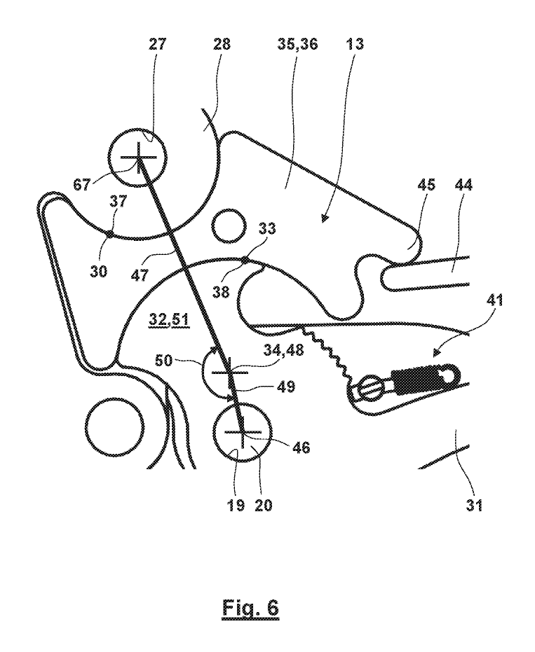

FIG. 5 shows the toggle lever drive 13 formed in this way in a detail in the open position, whereas FIG. 6 shows the toggle lever drive 13 in a corresponding representation in the closed position. In FIGS. 5 and 6 the centers of curvature 34, 67 of the contact contours 33, 30 are marked. A first toggle lever 47 is formed in the region of the connecting axis of the center of curvature 34 of the contact contour 33 with the center of curvature 67 of the contact contour 30 (which here corresponds to the axis of the mounting bore 27). An imaginary toggle joint 48 is formed at the center of curvature 34. A second toggle lever 49 of the toggle lever drive 13 is formed in the region of the connecting axis between the swivel axis 36 of the swivel joint 20 and the center of curvature 34. FIG. 5 shows that in the open position of the pliers 1 the toggle lever angle 50 is slightly >90° (e.g. in the region of 95° to 120°).

FIG. 6 shows the toggle lever drive 13 in the closed position, wherein the toggle lever angle 50 has come close to the extended position. Preferably, the toggle lever angle 50 is between 165° and 178° (e.g. between 170° and 175°).

FIGS. 5 and 6 show that the toggle levers 47, 49 are no physical, bar-like or rod-like toggle levers formed by singular constructional elements. However, in any specific operating position of the toggle lever drive 13 for an illustration it is possible to replace the imaginary toggle levers 47, 49 by real bar- or rod-like toggle levers resulting in the same force flow and the same kinematics. The imaginary toggle joint 48 is located in the center of curvature 34. The first toggle lever 47 is here formed by three separate constructional elements which are moved relative to each other when running through the working stroke, namely
the toggle lever component 28,
the toggle lever component 35 and
a toggle lever component 51 which is formed by the material of the protrusion 32 between the contact contour 33 and the center of curvature 34.

Instead, the toggle lever 39 is formed by the material of the protrusion 32 between the center of curvature 34 and the swivel axis 46.

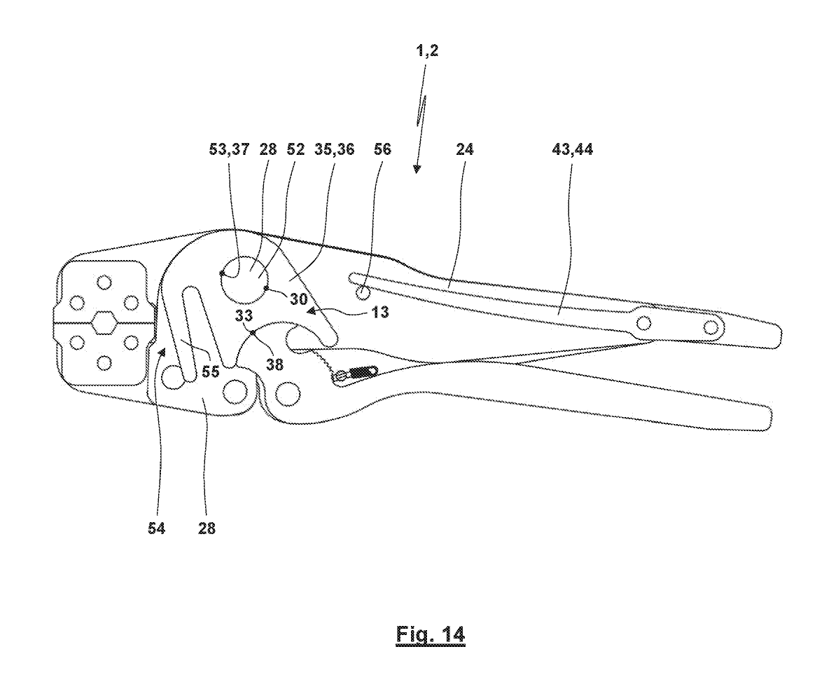

For the embodiment of FIG. 14 (with besides the following differences corresponding design) the contact contour 30 of the toggle lever component 28 is formed by a cylindrical pivot 52. In this case the toggle lever component 35 or the pressure body 36 comprise an inner bore 53 which in this case forms the contact contour 37.

As another option, another opening spring 54 is provided. The opening spring 54 is formed integrally by the toggle lever component 35 as a spring arm 55. When running through the working stroke and with the pivoting movement of the toggle lever component 35, the spring arm 55 abuts a stop (here not shown). With the further closing movement the spring arm 55 is elastically deformed. It is possible that the opening spring 34 is biased during the whole working stroke, whereas the opening spring 54 is only biased in the end region of the closing movement when approaching the closed position or the extended position of the toggle lever drive 13 and only serves for avoiding a clamping or blockage of the toggle lever drive 13 when reaching the closed position.

Furthermore, for the embodiment of FIG. 14 the pliers jaw supporting plate 24 carries a stop 56, here embodied as a bolt. With the pivoting movement of the pliers jaw supporting plate 24 the stop 56 biases the opening spring 43.

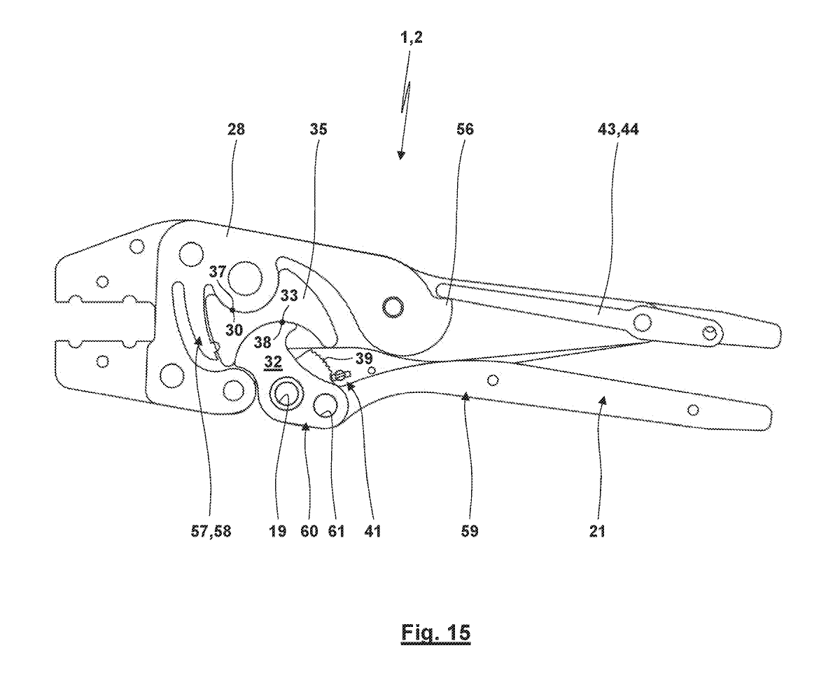

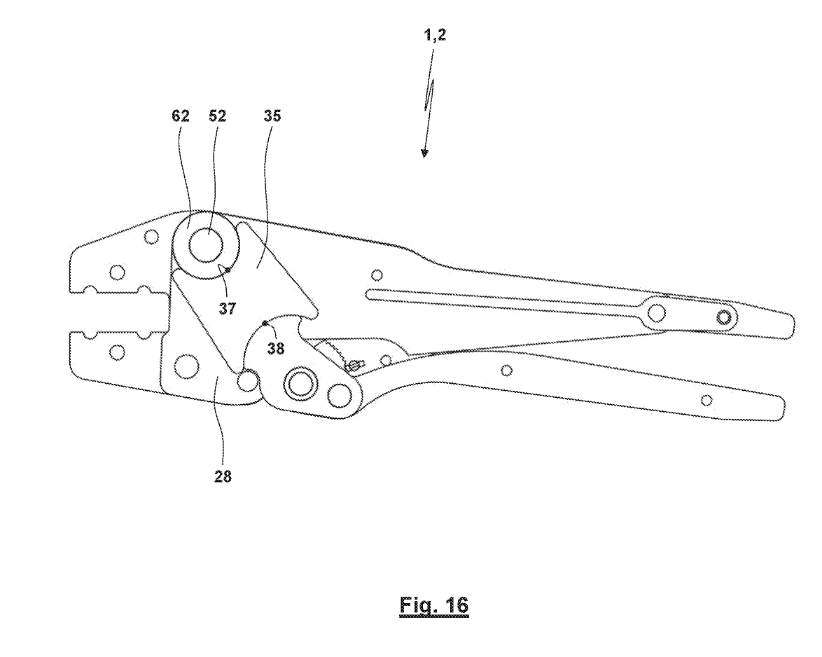

For the embodiment of FIG. 15, the stop 56 is formed by the toggle lever component 28. Furthermore, the toggle lever component 28 forms an opening spring 57, here in the form of a spring arm 58. In particular in the end region of the closing movement the spring arm 58 comes (under increasing bias) into contact with the toggle lever component 35.

For the embodiment of FIG. 15, the pliers body 21 has no one-piece design. Instead, here a pliers body part 59 forms the hand lever plate 31, a bearing bore 19 and the toothing 39 of the forced locking unit 41. A second pliers body part 60 forms the protrusion 32, the bearing bore 19 and the contact contour 33. The pliers body parts 59, 60 are arranged with an overlap (as can be seen in FIG. 15) and rigidly connected to each other by the bearing and fixing bolt extending through the bore 19 and an additional mounting bolt extending through a mounting bore 61.

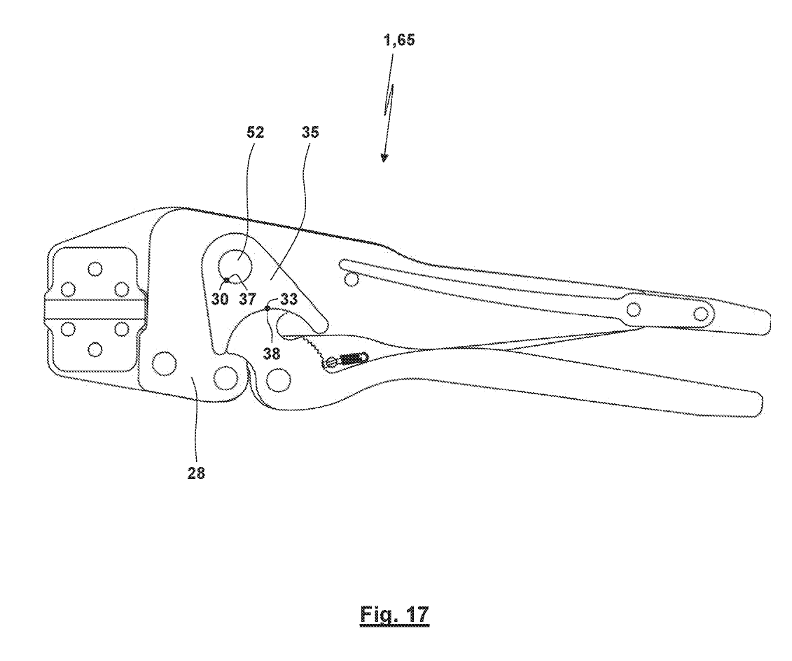

FIG. 16 shows an embodiment wherein in a rough approximation the toggle lever component 35 is rectangular with contact contours 37, 38 formed in the region of the opposing shorter sides of the rectangle. In this case the toggle lever component 28 comprises a pivot 52. Another toggle lever component 62, namely a sliding ring, is supported for being rotated by the pivot 52. During the working stroke with its outer surface the sliding ring rolls along the contact contour 37.

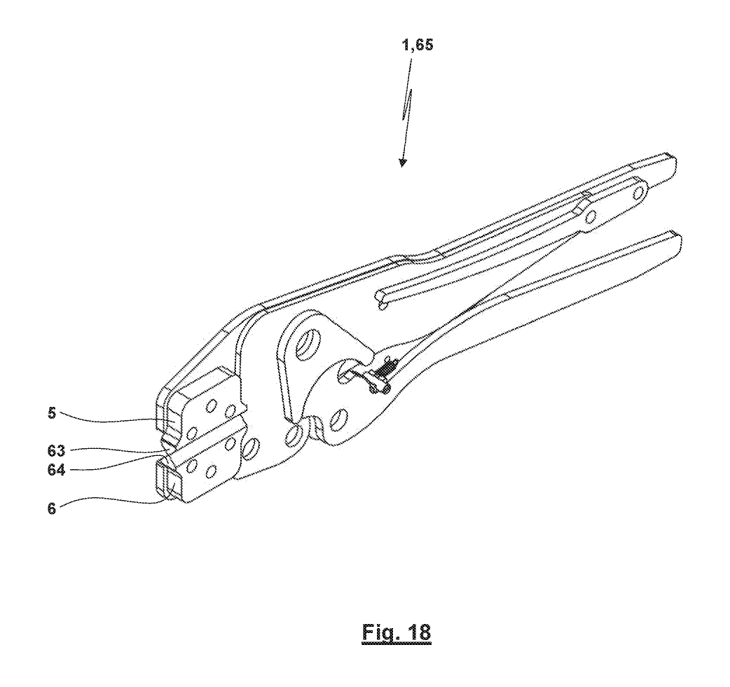

Also according to FIGS. 17 and 18 the toggle lever component 35 is supported for being rotated by a pivot 52 of the toggle lever component 28. Here, the outer surface of the pivot 52 forms the contact contour 30. In the three-dimensional view of FIG. 18 it can be seen that here the dies 5, 6 are no crimping dies but comprise cutting edges 63, 64 so that here the pliers 1 are embodied as cutting pliers 65.

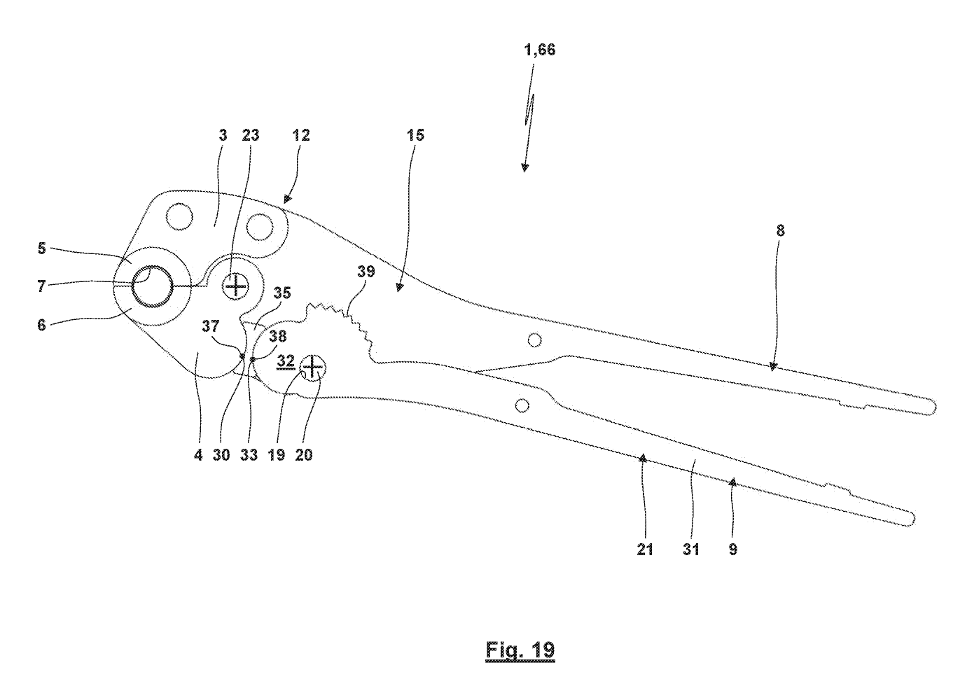

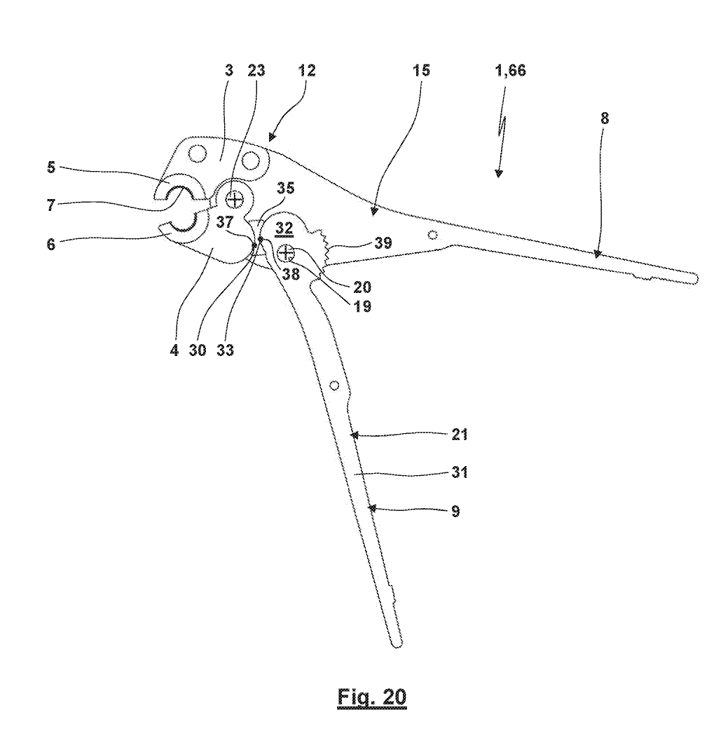

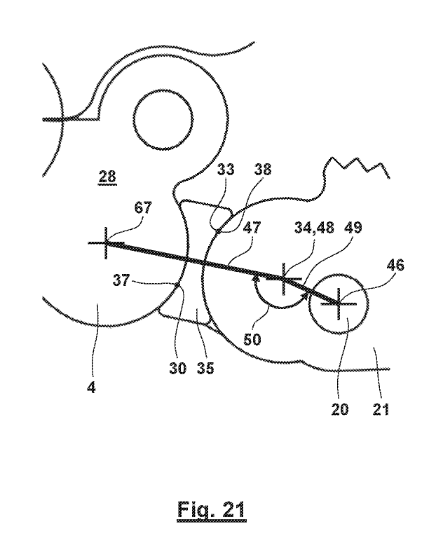

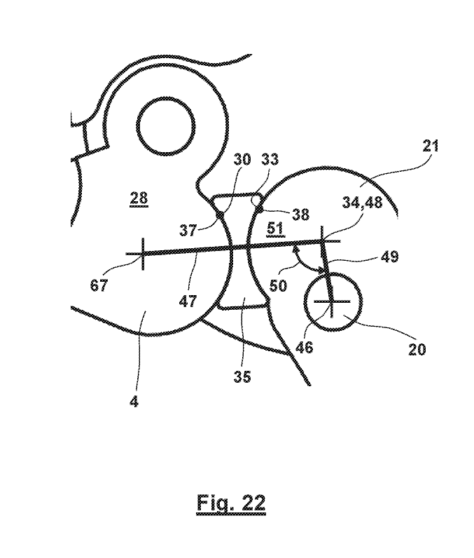

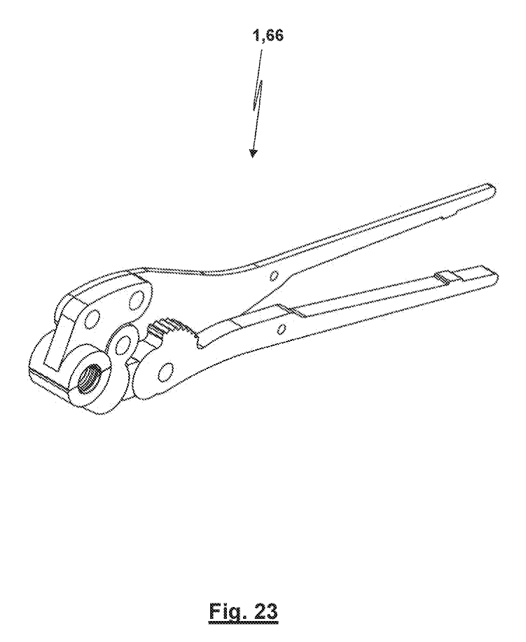

FIGS. 19 to 23 show pliers 1 embodied as pipe crimping pliers 66. Also here a pliers body 15 comprises a fixed hand lever 8 and a fixed pliers jaw 3 fixedly mounted to the fixed hand lever 8 with associated die 5. However, here the hand lever 8 and the pliers jaw 3 have a two-piece design and are connected to each other by mounting bolts. It is also possible that the die 5 is fixedly mounted to the pliers body 15 or exchangeable. For this embodiment the swivel joint 23 for the movable pliers jaw 4 is arranged in the region of the pliers head 12. The movable pliers jaw 4 carries a die 6. For the pipe crimping tool 66 the dies 5, 6 form an accommodation 7 for crimped fittings for a pipe connection. Also for this embodiment the pliers body 21 comprises the hand lever plate 31, the bearing bore 19 for the establishment of the swivel joint 20, the protrusion 32, the contact contour 33 and the toothing 39. However, the pliers body 21 has no cranking. Instead, here the protrusion 32 generally extends in a prolongation of the hand lever plate 31 beyond the swivel joint 20. With the contact contour 33 the pliers body 21 contacts the toggle lever component 35 in the region of its contact contour 38. On the opposite side the contact contour 37 of the toggle lever component 35 is in direct contact with a contact contour 30 which is formed by the movable pliers jaw 4.

Whereas FIG. 19 shows the pipe crimping pliers 66 in the closed position, FIG. 20 shows the pipe crimping pliers in the open position. In FIGS. 21 and 22 the toggle lever drive 13 is shown, namely in FIG. 21 in the closed position wherein the toggle lever angle 50 is close to the extended position (preferably with a toggle lever angle of 165° to 175°) and in FIG. 22 in the open position wherein the toggle lever angle is >90° (preferably in the region of 90° to 100°).

FIG. 23 shows the pipe crimping pliers 66 in the closed position in a three-dimensional view.

It is possible that the pliers body 21 forms a stop 68 by which the closed position is defined. It is e.g. possible that in the closed position according to FIG. 3 the stop 68 (7 which is here arranged in the region of the hand lever plate 31) contacts a corresponding stop 69 of the pliers jaw supporting plate 24.

Preferably, the pliers have a plate design with no bending form parts or milled parts. Instead, only punching parts are used. By the inventive design, in some cases it is also possible to reduce or minimize the number of punched parts. The punched parts required for the drive mechanic, in particular the toggle lever drive and the plates, are here preferably all located in one plane. Due to the comparatively large diameter of the contact contours, small surface pressures result in the contact areas despite of the large transferred forces. Accordingly, in some cases also thin plates (in particular with a thickness of less than 3.0 mm, 2.5 mm or even 2.0 mm) can be used for the force transfer.

The inventive toggle lever drive and further aspects of the invention can be used for pliers of any design. Accordingly, it is also possible to integrate the inventive measures into pliers according to the prior art mentioned in the beginning. In order to mention only some non-limiting examples, instead of the toggle lever drive of
crimping pliers according to DE 100 56 900 C1 with an O-shaped pliers head frame and dies moved by a translational relative movement,
cable cutting pliers according to DE 43 03 180 C1,
pipe crimping pliers according to DE 103 46 241 B3 wherein a ratchet transmission is integrated into one hand lever so that a closure of the pliers jaws can be achieved by a plurality of closing strokes of the hand levers,
crimping pliers with C-shaped pliers head frames,
pipe crimping pliers with a hand lever comprising two hand lever parts which can be brought into two different angular positions,
a spreading tool according to DE 10 2008 007 303 B4 or
a crimping tool corresponding to DE 10 2008 012 011 B3 or EP 2 672 581 A1 or
crimping pliers for crimping wire end sleeves with more than two dies which are actuated in radial direction and which are actuated by a pivot ring driven by the toggle lever drive

an inventive toggle lever drive 13 might be used.

It will be understood from the above specification that the toggle lever drive 13, the toggle levers 47, 49 and the toggle joint 48 do not build a common toggle lever drive, common toggle levers and a common toggle joint where the toggle levers are physically present real rod-like levers and the toggle joint is a physically present rotational joint of any type. Instead, the toggle lever drive 13 is an “imaginary” toggle lever drive with at least one toggle lever formed by a plurality of toggle lever components which can be moved relative to each other along contact contours. Furthermore, the “imaginary” toggle lever drive 13 comprises an “imaginary” toggle joint which results from the kinematic conditions (in particular the linkage of the toggle lever components to adjacent components as a crimping jaw or a hand lever and from the curvature of the contact contours) and which might be located within the body of one of the toggle lever components. An advantage of this design is that it is possible that the length of the toggle lever (and the position of the toggle joint) changes dependent on the toggle angle. For each single toggle angle (for an analogy observation) the kinematic, the force transfer and the transfer of the movements of the inventive pliers might also be provided by a real physical toggle lever drive with real toggle levers and a real toggle joint. However, in this case for any differing toggle angle it will be required to use at least one toggle lever having a differing length (which in praxis is not possible for real, physically present rod-like toggle levers but possible for the invention).

Many variations and modifications may be made to the preferred embodiments of the invention without departing substantially from the spirit and principles of the invention. All such modifications and variations are intended to be included herein within the scope of the present invention, as defined by the following claims.

I claim:

1. Pliers comprising
a) a first pliers jaw and a second pliers jaw, said second pliers jaw comprising a first contact contour and said first pliers jaw and said second pliers jaw being supported in a first swivel joint for a relative pivoting movement,
b) an actuation element being supported in a second swivel joint for a pivoting movement relative to the first pliers jaw, said actuation element comprising a second contact contour,
c) a pressure body having a third contact contour and a fourth contact contour, said third contact contour contacting the first contact contour of the second pliers jaw and said fourth contact contour contacting the second contact contour of the actuation element,
d) wherein the second pliers jaw, the pressure body and the actuation element are movable relative to each other along the contact contours,
e) wherein the second pliers jaw, the pressure body and the actuation element form a toggle lever drive by which the second pliers jaw is actuated, and
f) wherein the second pliers jaw, the pressure body and the actuation element each form a toggle lever component of a first toggle lever of the toggle lever drive wherein the length of the first toggle lever depends on the relative position of the second pliers jaw, the pressure body and the actuation element.

2. The pliers of claim 1, wherein
a) the actuation element comprises a movable hand lever,
b) the pliers comprise a fixed hand lever, and
c) a protrusion of the actuation element forms the second contact contour.

3. The pliers of claim 1, wherein the toggle lever component of the first toggle lever formed by the actuation element also forms a second toggle lever and wherein an imaginary toggle joint corresponds to the center of curvature of the second contact contour of the actuation element at its contact surface with the fourth contact contour of the pressure body.

4. The pliers of claim 1, wherein at least one contact contour of the toggle lever components is produced by punching.

5. The pliers of claim 1, wherein the contact contours have the shape of a circular arc.

6. The pliers of claim 2, wherein
a) a pliers body comprises the first pliers jaw and the fixed hand lever and
b) the second pliers jaw is pivotably linked to the pliers body by the first swivel joint which is located in the region of the fixed hand lever.

7. The pliers of claim 2, wherein the pressure body biases an opening spring.

8. The pliers of claim 7, wherein the opening spring is a leaf spring or bending spring which extends approximately parallel one of the hand levers.

9. The pliers of claim 1, wherein one of the toggle lever components integrally forms an opening spring.

10. The pliers of claim 2, wherein
a) one of the toggle lever components is rigidly connected to the movable hand lever and/or
b) one of the toggle lever components is rigidly or rotatably connected to the fixed hand lever.

11. The pliers of claim 1, wherein a pliers body forming the movable hand lever integrally comprises
a) the second toggle lever of the toggle lever drive,
b) a toothing of a forced locking unit,
c) a stop for defining a closed position of the pliers and/or
d) a contact contour.

12. The pliers of claim 2, wherein the toggle lever drive is arranged between the hand levers and dies, said dies being associated to the pliers jaws.

13. The pliers of claim 1, wherein
a) the angle of the pliers jaws changes over the working stroke by less than 5°,
b) the length of the pliers is less than 250 mm,
c) the height of the pliers is less than 60 mm and/or
d) the thickness of the pliers is less than 15 mm.

14. The pliers of claim 1 embodied as pipe crimping pliers, crimping pliers or cutting pliers.
